(19) United States
(12) Patent Application Publication
(10) Pub. No.: US 2012/0208693 A1
(43) Pub. Date: Aug. 16, 2012

(54) Graphite Particle-Supported Pt and Pt Alloy Electrocatalyst with Controlled Exposure of Defined Crystal Faces for Oxygen Reduction Reaction (ORR)

(75) Inventors: Junliang Zhang, Rochester, NY (US); Zhiqiang Yu, Rochester, NY (US); Zhongyi Liu, Troy, MI (US)

(73) Assignee: GM GLOBAL TECHNOLOGY OPERATIONS LLC, Detroit, MI (US)

(21) Appl. No.: 13/027,908

(22) Filed: Feb. 15, 2011

(51) Int. Cl. H01M 4/88

(52) U.S. Cl. 502/101

(57) ABSTRACT

A method for forming an electrocatalyst for fuel cell applications comprises electrolessly depositing a first plurality of nickel particles onto carbon-support particles. The nickel particles are formed from a nickel ion-containing aqueous solution. At least a portion of the nickel particles are replaced with platinum via a galvanic displacement reaction to form a second plurality of nickel particles coated with a platinum layer. During this displacement reaction step, the nickel particles are heated to a temperature sufficient to form the platinum layer. Finally, the second plurality of nickel particles is optionally incorporated into a cathode layer of a fuel cell.

### BACKGROUND OF THE INVENTION

1. Field of the Invention

The present invention is related to electrocatalysts used for fuel cell applications.

2. Background

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel and oxidant to disperse over the surface of the membrane facing the fuel- and oxidant-supply electrodes, respectively. Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Conventional Pt/C electrocatalysts have considerable difficulty in meeting the requisite activity and durability requirements of auto-competitive targets. Corrosion-resistant graphitized carbon supported uniformly dispersed Pt alloy nano-crystalline electrocatalysts with controlled particle size and shape provides significant activity and durability advantages. However, due to its low surface energy and lack of functional groups graphitized carbon surfaces are not favored nucleation centers for metal particles to grow. Moreover, considerable non-uniformity of the catalyst dispersion has been observed in commercial graphitized carbon supported Pt catalysts and alloys in which, Pt preferentially grows along the edges and steps, causing lower utilization efficiency of the catalyst and large gas and proton transport resistance. Another shortcoming of the commercial Pt alloy catalyst is no shape control of the Pt alloy particles. As reported in the literature, Pt₃Ni(111) surface has much higher activity than other surfaces, so that selective (111) surface exposure of the Pt3Ni alloy catalyst is desired.

Accordingly, there is a need for improved methodology for applying hydrophilic coatings at the surfaces of bipolar plates used in fuel cell applications.

### SUMMARY OF THE INVENTION

The present invention solves one or more problems of the prior art by providing in at least one embodiment a method for preparing an electrocatalyst. The method comprises activating a plurality of carbon-support particles by contacting the carbon support particles with an acid solution and then optionally depositing a trace amount of palladium on the carbon-support particles to form palladium-containing carbon support particles. Nickel is then deposited onto the palladium-containing carbon support particles. The nickel is formed from a nickel ion-containing solution. The nickel is reacted with a platinum-containing solution at a sufficient temperature to form a platinum-nickel alloy disposed on the carbon support particles. Finally, the platinum-nickel alloy disposed on the carbon support particles is incorporated into a catalyst layer (e.g., cathode layer) of the fuel cell.

In another embodiment a method for preparing an electrocatalyst. The method comprises activating a plurality of carbon-support particles by contacting the carbon support particles with an acid solution and then optionally depositing a trace amount of palladium on the carbon-support particles to form palladium-containing carbon support particles. Nickel is then deposited onto the palladium-containing carbon support particles. The nickel is formed from an aqueous nickel ion-containing solution. The nickel is reacted with a platinum-containing solution at a sufficient temperature to form a crystalline platinum-nickel alloy disposed on the carbon support particles. Finally, the crystalline platinum-nickel alloy disposed on the carbon support particles is incorporated into a catalyst layer (e.g., cathode layer) of the fuel cell.

### BRIEF DESCRIPTION OF THE DRAWINGS

FIG. 1 is a cross sectional view of a fuel cell incorporating the bipolar plates of an embodiment of the present invention;

FIGS. 2A, 2B, and 2C are schematic flowcharts illustrating a method for making an electrocatalyst for fuel cell applications; and

FIG. 3 provides a high resolution transmission electron micrograph (TEM) image of the synthesized PtNi alloy crystalline particles supported on graphite;

FIG. 4 provided TEM-EDX spectroscopy of the particles, indicating the particles containing both Pt and Ni elements;

FIG. 5 provides polarization curves tested on a rotating disk electrode using the Pt/Ni particles of an embodiment of the invention;

FIG. 6A provides a transmission electron micrograph for PtNi crystalline particles deposited on graphitized Vulcan carbon particles; and

FIG. 6B provides a transmission electron micrograph for a commercial graphitized Vulcan supported Pt catalyst.

### DETAILED DESCRIPTION OF THE PREFERRED EMBODIMENT(S)

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

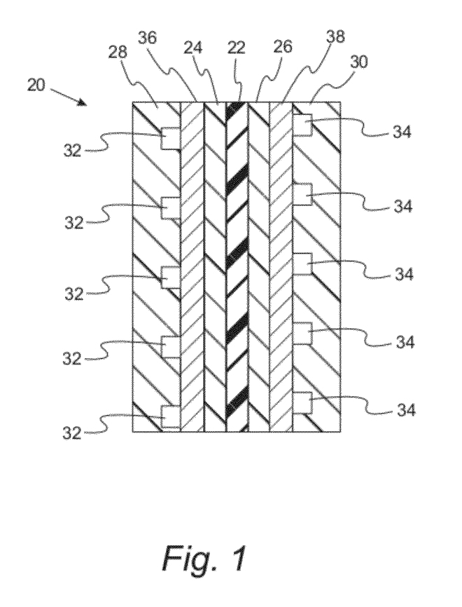

With reference to FIG. 1, a cross sectional view of a fuel cell that incorporates an embodiment of a flow field plate is provided. PEM fuel cell 20 includes polymeric ion conducting membrane 22 disposed between cathode catalyst layer 24 and anode catalyst layer 26. Fuel cell 20 also includes electrically conductive flow field plates 28, 30 which include gas channels 32 and 34. Flow field plates 28, 30 are either bipolar plates (illustrated) or unipolar plates (i.e., end plates). In a refinement, flow field plates 28, 30 are formed from a metal plate (e.g., stainless steel) optionally coated with a precious metal such as gold or platinum. In another refinement, flow field plates 28, 30 are formed from conducting polymers which also are optionally coated with a precious metal. Gas diffusion layers 36 and 38 are also interposed between flow field plates and a catalyst layer. Advantageously, flow field plates 28, 30 are made by the processes set forth below.

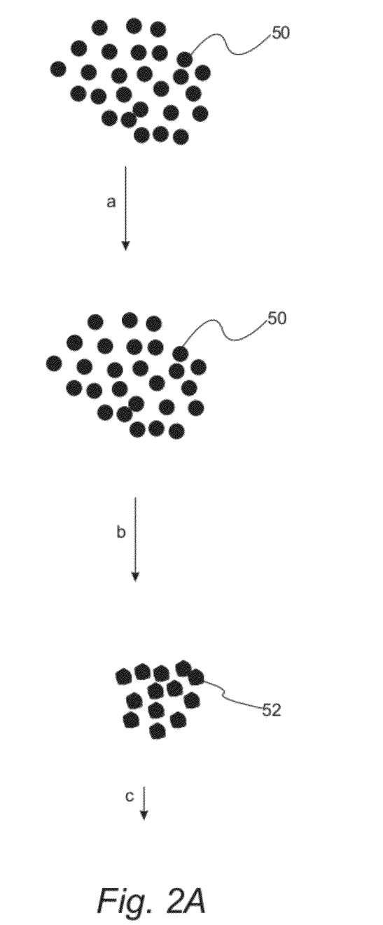

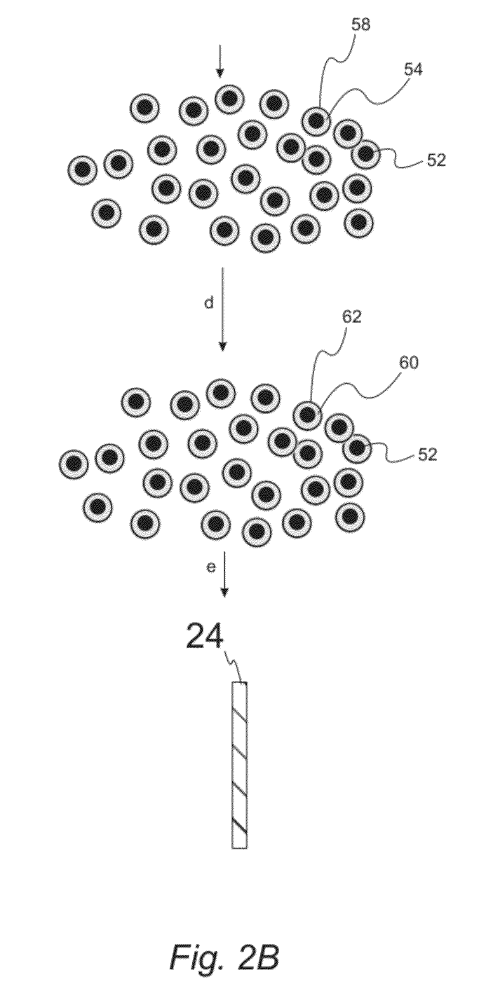

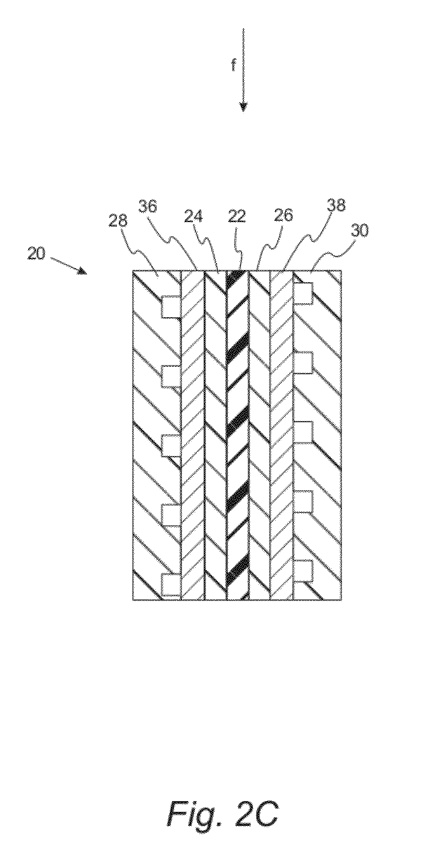

With reference to FIG. 2, a flowchart illustrating the formation of an electrocatalyst is provided. In step a), carbon-containing particles 50 are cleaned and then activated by contact with an acidic solution. Graphite particles are found to be particularly useful for forming the electrocatalysts. In a variation, the graphite particles are characterized by a spatial dimension from about 10 nm to 1.2 microns. As used herein, when a value is given for the spatial dimension of particles, such a dimension is the diameter of a sphere having a volume equal to the average volume of the particles. In a refinement, the spatial dimension means that the particles do not have any spatial dimension of greater value. For spherical particles, the characteristic spatial dimension is simply the diameter. In a refinement, the carbon-containing particles are activated by heat treatment with aqueous HNO₃. In another refinement, the activation is accomplished by contacting carbon-containing particles 50 with a SnCl₂/HCl solution. Typically, the activation step is performed at an elevated temperature from about 50 to 100° C. for several hours (i.e., 1 to 10 hours).

In the next step b), carbon particles 50 are seeded with a trace amount of palladium to form palladium-containing carbon particles 52. In a refinement, the palladium is present on the carbon particles in an amount from about 0.5 to about 5 weight percent of the combined weight of the palladium and carbon.

In step c), nickel layer 54 is deposited on the palladium-containing carbon particles 52 by contacting the palladium-containing carbon particles 52 with an electroless reaction solution to form nickel coated carbon particles 58. Electroless in the present context means that the nickel particles are formed without passing an electric current through the solution. The electroless reaction solution includes a nickel ion-containing (e.g., Ni²⁺) aqueous solution. This electroless reaction solution is reacted with a reducing agent. The nickel ions are typically formed by dissolving a nickel salt into a water-containing solution. Examples of suitable nickel salts include, but are not limited to, nickel chloride, nickel sulfate, nickel sulfamate, nickel acetate, nickel hypophosphite, and combinations thereof. Examples of suitable reducing agents include, but are not limited to, sodium hypophosphite, sodium borohydride and dimethylamineborane. In a variation, the nickel layer has a thickness from about 1 nm to about 10 nm.

The pH of the electroless reaction solution is adjusted to a pH that is greater than about 7. In another variation, the pH of the electroless reaction solution is adjusted to a pH from about 8 to about 11. In still another variation, the pH of the electroless reaction solution is adjusted to a pH from about 8 to about 10. In yet another variation, the pH of the electroless reaction solution is adjusted to a pH of about 9.

The chemical reactions leading to the formation of the nickel particles is described by the following reactions:

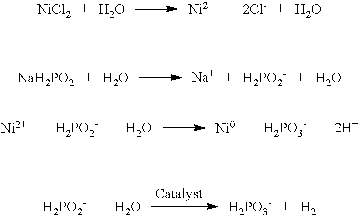

In step d), the nickel coated carbon particles 58 are transferred to a high boiling organic solvent. A platinum containing compound is also added to the high boiling organic solvent. The resulting mixture is then heated to an elevated temperature for several hours (i.e., 1 to 7 hours). Typically, the mixture is heated to a temperature from about 130° C. to 230° C. Examples of suitable platinum containing compounds include, but are not limited to K₂PtCl₄, H₂PtCl₄, H₂PtCl₆, (NH₃)₂Pt(NO₂)₂, (NH₃)₂PtCl₂, Pt(acac)₂, Pt(C₂H₃O₂)₂, and hydrated forms thereof, and combinations thereof. The platinum ion-containing solution is heated to a temperature sufficient to form platinum/nickel alloy 60 deposited on the carbon particles (platinum-nickel alloy coated carbon particles 62). In a refinement, platinum/nickel alloy 60 is crystalline. In a further refinement, platinum/nickel alloy 60 is nano-crystalline have a spatial dimension from about 3 to about 50 nm. In a further refinement, platinum/nickel alloy 60 is nano-crystalline have a spatial dimension from about 3 to about 10 nm. In still a further refinement, platinum/nickel alloy 60 comprises a uniformly dispersed 5-7 nm PtNi nano-crystalline particles. In this latter refinement, the PtNi nano-crystalline particles are generated with significant portion of particles having tetrahedron and hexahedron shape. In general, the all particle dimensions are within the specified ranges. These two types of single crystals have are observed to have the majority of their surface atoms arranged in (111) orientation, which has high activity and durability than other facets. The molar ratio of Pt:Ni can be adjusted by varying the amount of platinum containing compound in the mixture or the duration of the electroless nickel plating of the amount of nickel containing compound.

In step e), the platinum/nickel alloy 60 deposited on the carbon particles are optionally incorporated into cathode layer 24. In a refinement, the platinum coated nickel particles disposed on the carbon-support particles are incorporated into an ink from which an electrocatalyst layer is formed (e.g. cathode layer). In a further refinement, the ink is printed onto the ion conducting polymeric membrane. U.S. Pat. Appl. No. 20060257719 provided methods for forming such inks with platinum loaded carbon powders which can be adapted for this purpose. The entire disclosure of this application is hereby incorporated by reference. Typically, the loading of the nickel particles is such that the platinum loading is from about 10 μgPt/cm² to about 400 μgPt/cm². In a refinement, the nickel particles are such that the platinum loading is from about 20 μgPt/cm² to about 200 μgPt/cm². In another refinement, the nickel particles are such that the platinum loading is from about 50 μgPt/cm² to about 100 μgPt/cm². Finally, the cathode layer is then incorporated into fuel cell 20 in step f).

The following examples illustrate the various embodiments of the present invention. Those skilled in the art will recognize many variations that are within the spirit of the present invention and scope of the claims.

About 2 grams of graphitized carbon are soaked and stirred in 500 ml (SnCl2+HCl) solution containing 10 g/l SnCl₂ and 30 ml/l concentrated HCl for 30 minutes. The SnCl₂+HCl solution has a high oxidation strength, which can effectively activate the graphite basal plane with oxygenated groups. The activated carbon particles are then soaked in a mixed solution for 15 minutes that contained 0.25 g/l PdCl₂ and 3 ml/l concentrated HCl to seed the surface with trace amount of Pd. Then the graphitized carbon particles are soaked in a Ni electroless plating bath (containing NiCl₂+sodium hypophosphite+sodium citrate+ammonium chloride) and heated to 80° C. and held at 80° C. for 30 minutes. A thin layer of Ni is plated on the carbon surface. Finally, the Ni coated carbon particles are filtered out and transferred into 500 ml ethylene glycol solution containing 0.8 g Pt(acac)₂ and a 0.2 g triethanol amine. The mixture is heated to 180° C. hold at that temperature for 4 hours. A uniformly dispersed 5-7 nm PtNi nano-crystalline particles is generated with significant portion of particles having tetrahedron and hexahedron shape.

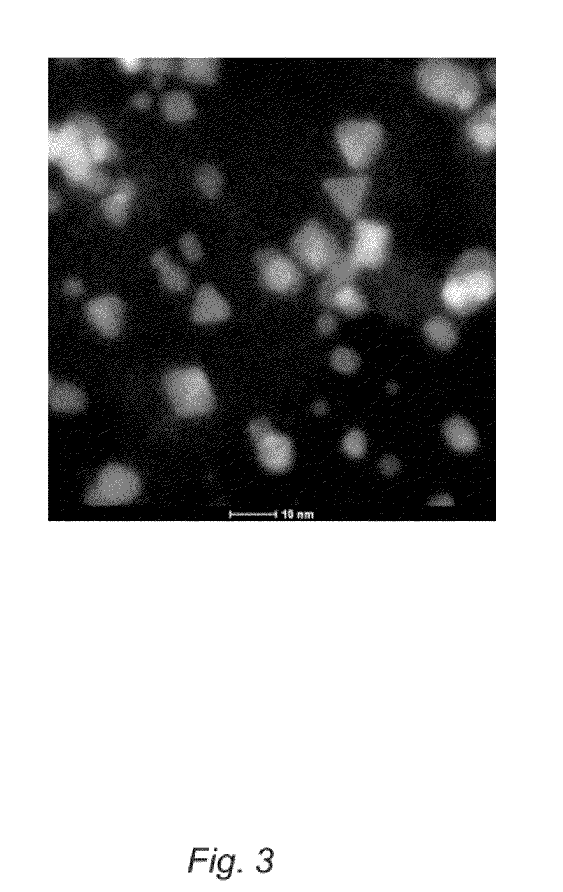

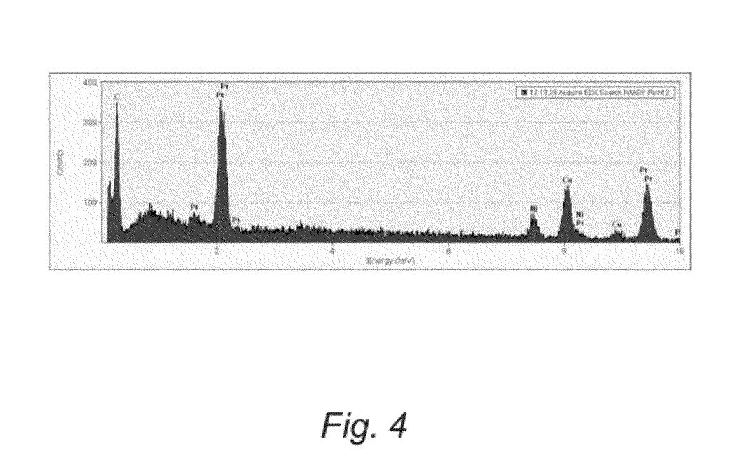

FIG. 3 provides a high resolution transmission electronmicrograph (TEM) image of the synthesized PtNi alloy crystalline particles supported on graphite. As we can see from the image, uniformly dispersed 5-7 nm PtNi nano-crystals supported on graphite particles were generated with a significant portion of crystals having tetrahedral and octhedral form. FIG. 4 provided TEM-EDX spectroscopy of the particles, indicating the particles containing both Pt and Ni elements. The Cu signal therein is from the catalyst sample holder.

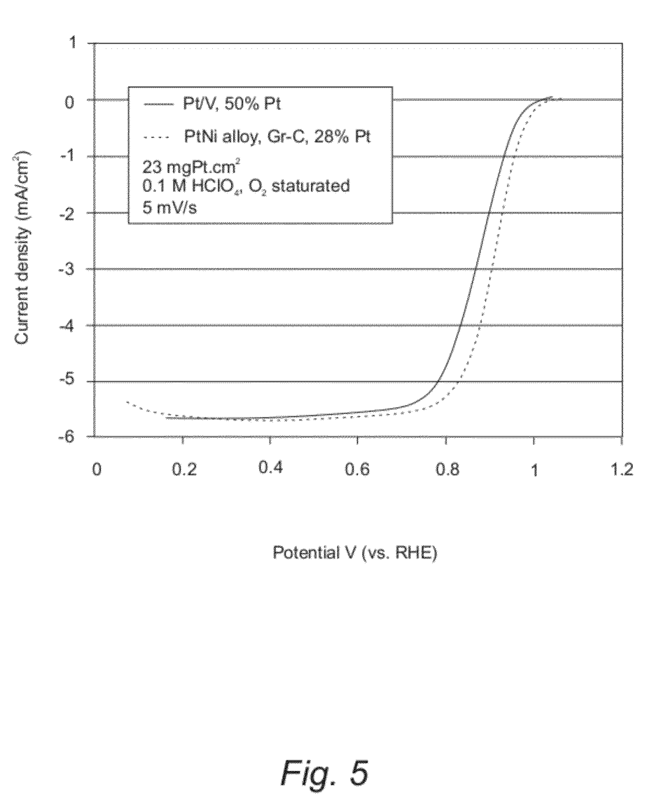

FIG. 5 provides polarization curves tested on a rotating disk electrode (“RDE”). The details of preparation of catalyst layer on the RDE electrode can be found in Schmidt T J, Gasteiger H A, Stab G D, Urban P M, Kolb D M, Behm R J (1998) Characterization of high-surface area electrocatalysts using a rotating disk electrode configuration. J. Electrochem. Soc., 145(7): p. 2354-2358 and Zhang J, Mo Y, Vukmirovic M B, Klie R, Sasaki K, Adzic R R (2004) Platinum monolayer electrocatalysts for O₂ reduction: Pt monolayer on Pd(111) and on carbon-supported Pd nanoparticles. J. Phys. Chem. B, 108(30): p. 10955-10964. The Pt loading on the electrode was adjusted to be 23 μgPt/cm². The test is carried out in 0.1M HClO₄ solution saturated with O₂, and the scan rate was 5 mV/s. The measured Pt mass activity of the supported PtNi crystalline catalyst at 0.9V is 0.4 A/mg Pt, which is about 3 times that of standard Pt/V catalyst. The Pt mass activity of standard Pt/V catalyst is 0.13 A/mg Pt.

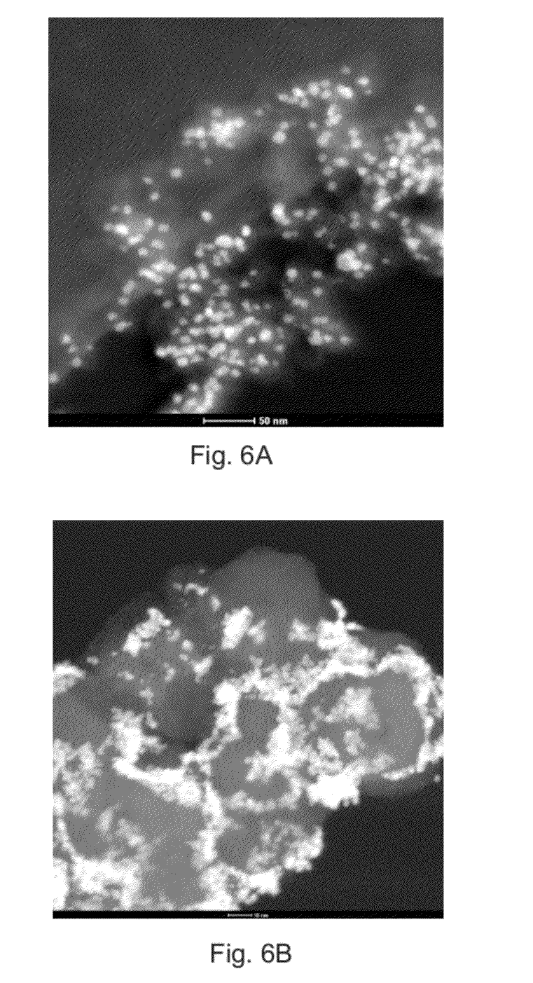

FIG. 6A provides a transmission electron micrograph (TEM) for PtNi crystalline particles deposited on graphitized Vulcan carbon particles. In FIG. 6A, the TEM image shows that the PtNi alloy particle dispersion on the graphitized Vulcan support are more uniform than the commercial graphitized Vulcan supported Pt catalyst (FIG. 6B). The uniformity of catalyst dispersion on carbon support advantageously improves fuel cell performance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for forming an electrocatalyst for use in a fuel cell, the method comprising:
a) activating a plurality of carbon-support particles by contacting the carbon support particles with an acid solution;
b) optionally depositing a trace amount of palladium on the carbon-support particles to form palladium-containing carbon support particles;
c) electrolessly depositing nickel onto the palladium-containing carbon support particles, the nickel being formed from an aqueous nickel ion-containing solution;
d) reacting the nickel with a platinum-containing solution at a sufficient temperature to form a platinum-nickel alloy disposed on the carbon support particles; and
e) incorporating the platinum-nickel alloy disposed on the carbon support particles into a cathode layer of the fuel cell.

2. The method of claim 1 wherein a platinum-nickel alloy disposed on the carbon support particles is crystalline.

3. The method of claim 1 wherein a platinum-nickel alloy is oriented along the (111) direction.

4. The method of claim 1 wherein a platinum-nickel alloy has a spatial dimension from 3 to 100 nm.

5. The method of claim 1 wherein a platinum-nickel alloy comprises tetrahedron and hexahedron-shaped particles.

6. The method of claim 1 wherein the nickel is reacted with the platinum-containing solution at a temperature of 130° C. to 230° C.

7. The method of claim 1 wherein the carbon-support particles comprise graphite.

8. The method of claim 1 wherein the platinum ion containing solution is formed by dissolving a platinum-containing compound in a solvent, the platinum containing compound comprising a component selected from the group consisting of K₂PtCl₄, H₂PtCl₄, H₂PtCl₆, (NH₃)₂Pt(NO₂)₂, (NH₃)₂PtCl₂, Pt(acac)₂, Pt(C₂H₃O₂)₂, and their hydrated forms.

9. The method of claim 1 wherein the pH of the nickel ion-containing solution is adjusted to a pH greater than 7.

10. The method of claim 1 wherein the pH of the nickel ion-containing solution is adjusted to a pH from about 8 to about 10.

11. The method of claim 1 wherein the nickel is formed by reacting the nickel ion-containing solution with a reducing agent.

12. The method of claim 11 wherein nickel ions are formed by dissolving a nickel salt into a water containing solution, the nickel salt comprising a component selected from the group consisting of nickel chloride, nickel sulfate, nickel sulfamate, nickel acetate, nickel hypophosphite, and combinations thereof.

13. The method of claim 12 wherein the reducing agent is selected from the group consisting of sodium hypophosphite, sodium borohydride and dimethylamineborane.

14. A method for forming an electrocatalyst for use in a fuel cell, the method comprising:
a) activating a plurality of carbon-support particles by contacting the carbon support particles with an acid solution;
b) electrolessly depositing nickel onto the palladium-containing carbon support particles, the nickel being formed from an aqueous nickel ion-containing solution;
c) reacting the nickel with a platinum-containing solution at a temperature from 130° C. to 230° C. to form a crystalline platinum-nickel alloy disposed on the carbon support particles; and
d) incorporating the platinum-nickel alloy disposed on the carbon support particles into a cathode layer of the fuel cell.

15. The method of claim 14 wherein a platinum-nickel alloy has a spatial dimension from 3 to 100 nm.

16. The method of claim 14 wherein a platinum-nickel alloy comprises tetrahedron and hexahedron-shaped particles.

17. The method of claim 14 wherein the carbon-support particles comprise graphite.

18. The method of claim 14 wherein the platinum ion containing solution is formed by dissolving a platinum-containing compound in a solvent, the platinum containing compound comprising a component selected from the group consisting of K₂PtCl₄, H₂PtCl₄, H₂PtCl₆, (NH₃)₂Pt(NO₂)₂, (NH₃)₂PtCl₂, Pt(acac)₂, Pt(C₂H₃O₂)₂, and their hydrated forms.

19. The method of claim 14 wherein the nickel is formed by reacting the nickel ion-containing solution with a reducing agent.

20. The method of claim 19 wherein nickel ions are formed by dissolving a nickel salt into a water containing solution, the nickel salt comprising a component selected from the group consisting of nickel chloride, nickel sulfate, nickel sulfamate, nickel acetate, nickel hypophosphite, and combinations thereof.
